(19) United States
(12) Patent Application Publication
(10) Pub. No.: US 2006/0291769 A1
(43) Pub. Date: Dec. 28, 2006

(54) Light emitting source incorporating vertical cavity lasers and other MEMS devices within an electro-optical addressing architecture

(75) Inventors: John P. Spoonhower, Webster, NY (US); David L. Patton, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/139,289

(22) Filed: May 27, 2005

(51) Int. Cl. G02B 6/12

(52) U.S. Cl. 385/14

(57) ABSTRACT

A light source device and method of operating the light source device. The light source device comprising a support substrate, a plurality of light emitting etch structures placed in a matrix on the support substrate forming a plurality of rows and columns of the light emitting etch structures, a plurality of light waveguides positioned on the substrate such that each of the light emitting etch structures is associated with an electro-coupling region with respect to one of the plurality of light waveguides, a deflection mechanism for causing relative movement between a portion of at least one of the plurality of light waveguides and the associated light emitting etch structure so as to control when the light emitting etch structure is in the electro-coupling region, and a light source associated with each of the plurality of light waveguides for transmitting a light along the plurality of light waveguides for selectively activating each of the light emitting etch structures when positioned within the electro-coupling region.

### FIELD OF THE INVENTION

A flat panel light source system wherein optical waveguides and other thin film structures are used to distribute (address) excitation light to a patterned array of light emitting pixels.

### BACKGROUND OF THE INVENTION

A flat panel light source system is based on the generation of photo-luminescence within a light cavity structure. Optical power is delivered to the light emissive pixels in a controlled fashion through the use of optical waveguides and a novel addressing scheme employing Micro-Electro-Mechanical Systems (MEMS) devices. The energy efficiency of the light source results from employing efficient, innovative photo-luminescent species in the emissive pixels and from an optical cavity architecture, which enhances the excitation processes operating inside the pixel. The present system is thin, light weight, power efficient and cost competitive to produce when compared to existing technologies. Further advantages realized by the present system include brightness in varying lighting conditions, high color gamut, viewing angle control, size scalability without brightness and color quality sacrifice, rugged solid-state construction, vibration insensitivity and size independence. The present invention has potential applications in military, personal computing and digital HDTV systems, multi-media, medical and broadband imaging light sources and large-screen light source systems. Defense applications may range from full-color, high-resolution, see-through binocular light sources to 60-inch diagonal digital command center light sources. The new light source system employs the physical phenomena of photo-luminescence in a flat-panel light source system.

Conventional transmissive liquid crystal displays (LCDs) use a white backlight, together with patterned color filter arrays (CFAs), to create colored pixel elements as a means of displaying color. Polarizing films polarize light. The pixels in a conventional liquid crystal display are turned on or off through the use of an additional layer of liquid crystals in combination with two crossed polarizer structures on opposite sides of a layer of polarizing liquid crystals. When placed in an electrical field with a first orientation, the additional liquid crystals do not alter the light polarization. When the electrical field is changed to a second orientation, the additional liquid crystals alter the light polarization. When light from the polarizing liquid crystals is oriented at ninety degrees to the orientation of the polarizing film in a first orientation, no light passes through the display, hence, creating a dark spot. In a second orientation, the liquid crystals do rotate the light polarization; hence, light passes through the crystals and polarizing structures to create a bright spot having a color as determined by the color filter array.

This conventional design for creating a display suffers from the need to use a polarizing film to create polarized light. Approximately one half of the light is lost from the backlight, thus reducing power efficiency. Just as significantly, imperfect polarization provided by the polarizing film reduces the contrast of the display. Moreover, the required additional use of a color filter array to provide colored light from a white light source further reduces power efficiency. If each color filter for a tri-color red, green, and blue display passes one third of the white light, then two thirds of the white light is lost. Therefore, at least 84% of the white light generated by a backlight is lost.

The use of organic light emitting diodes (OLEDs) to provide a backlight to a liquid crystal display is known. For example, U.S. Patent Application Publication No. 2002/0085143 A1, by Jeong Hyun Kim et al., published Jul. 4, 2002, titled “Liquid Crystal Display Device And Method For Fabricating The Same,” describes a liquid crystal display (LCD) device, including a first substrate and a second substrate; an organic light emitting element formed by interposing a first insulating layer on an outer surface of the first substrate; a second insulating layer and a protective layer formed in order over an entire surface of the organic light emitting element; a thin film transistor formed on the first substrate; a passivation layer formed over an entire surface of the first substrate including the thin film transistor; a pixel electrode formed on the passivation layer to be connected to the thin film transistor; a common electrode formed on the second substrate; and a liquid crystal layer formed between the first substrate and the second substrate.

A method for fabricating the LCD in U.S. Patent Application Publication No. 2002/0085143 A1 includes the steps of forming a first insulating layer on an outer surface of a first substrate; forming an organic light emitting element on the first insulating layer; forming a second insulating layer over an entire surface of the organic light emitting element; forming a protective layer on the second insulating layer; forming a thin film transistor on the first substrate; forming a passivation layer over an entire surface of the first substrate including the thin film transistor; forming a pixel electrode on the passivation layer; and forming a liquid crystal layer between the first substrate and a second substrate. However, this prior art design does not disclose a means to increase the efficiency of the LCD.

U.S. Pat. No. 6,485,884 issued Nov. 26, 2002 to Martin B. Wolk et al., titled “Method For Patterning Oriented Materials For Organic Electronic Displays And Devices” discloses the use of patterned polarized light emitters as a means to improve the efficiency of a display. The method includes selective thermal transfer of an oriented, electronically active, or emissive material from a thermal donor sheet to a receptor. The method can be used to make organic electroluminescent devices and displays that emit polarized light. There remains a problem, however, in that there continues to exist incomplete orientation of the electronically active or emissive material from a thermal donor sheet to a receptor. Hence, the polarization of the emitted light is not strictly linearly polarized, therefore, the light is incompletely polarized.

There is a need, therefore, for an alternative backlight design that improves the efficiency of polarized light production, thus and thereby improving the overall efficiency of a liquid crystal display that incorporates the alternative backlight.

Stereoscopic displays are also known in the art. These displays may be formed using a number of techniques; including barrier screens such as discussed by Montgomery in U.S. Pat. No. 6,459,532 and optical elements such as lenticular lenses as discussed by Tutt et al in U.S. Patent Application 2002/0075566. Each of these techniques concentrates the light from the display into a narrow viewing angle, providing an auto-stereoscopic image. Unfortunately, these techniques typically reduce the perceived spatial resolution of the display since half of the columns in the display are used to display an image to either the right or left eye. These displays also reduce the viewing angle of the display, reducing the ability for multiple users to share and discuss the stereoscopic image that is being shown on the display.

Among the most commercially successful stereoscopic displays to date have been displays that either employed some method of shuttering light such that the light from one frame of data is able to enter only the left or right eye and left and right eye images are shown in rapid succession. Two methods have been employed in this domain including displays that employ active shutter glasses or passive polarizing glasses. Systems employing shutter glasses display either a right or left eye image while an observer wears active LCD shutters that allow the light from the display to pass to only the appropriate eye. While this technique has the advantage that it allows a user to see the full resolution of the display and allow the user to switch from a monoscopic to a stereoscopic viewing mode, the update rate of the display is typically on the order of 120 Hz, providing a 60 Hz image to each eye. At this relatively low refresh rate, most observers will experience flicker resulting in significant discomfort if the display is used for more than a few minutes within a single viewing session. Even when the display is refreshed at significantly higher rates, flicker is often visible when the display is large and/or high in luminance.

Byatt, 1981 (U.S. Pat. No. 4,281,341) has described a system employing a switchable polarizer that is placed in front of a CRT and performs very similarly to shutter glasses, using the polarization to select which eye will see each image. This system has the advantage over shutter glasses that the user does not need to wear active glasses, but otherwise suffers from the same deficiencies, including flicker.

Lipton, 1985 (U.S. Pat. No. 4,523,226) described a display system that will not suffer from flicker, but instead uses two separate video displays and optics to present the images from the two screens appropriately for the two eyes. While this display system does not suffer from the same visual artifacts as the system employing switchable polarization that was described by Byatt, the system requires two separate visual displays and additional optics, providing increasing the cost of such a system.

Previously, Newsome disclosed the use of upconverting phosphors and optical matrix addressing scheme to produce a visible light source in U.S. Pat. No. 6,028,977. Upconverting phosphors are excited by infrared light; this method of visible light generation is typically less efficient than downconversion (luminescent) methods like direct fluorescence or phosphorescence, to produce visible light. Furthermore, the present invention differs from the prior art in that a different addressing scheme is employed to activate light emission from a particular emissive pixel. The method and device disclosed herein does not require that two optical waveguides intersect at each light emissive pixel. Furthermore, novel optical cavity structures, in the form of optical light emitting etch structures, are disclosed for the emissive pixels in the present invention.

Additionally, in U.S. Patent Application Publication US2002/0003928A1, Bischel et al. discloses a number of structures for coupling light from the optical waveguide to a radiating pixel element. The use of reflective structures to redirect some of the excitation energy to the emissive medium is disclosed.

In U.S. Patent Application Publication US2004/0240782A1, de Almeida et al. disclose the use of light scattering planar optical etch structures to produce light emitting elements. Details relating to the mechanism for providing the light scattering are disclosed. These include modification of the top surface of the planar optical etch structure by a variety of surface corrugations and additionally control of the distribution of light from OLED light sources. The control mechanism makes use of the electro-optic effect to modifying the local index of refraction in the coupling region to affect power transfer to the emitting etch structure.

Recently, the optical properties of asymmetrical microdisk resonators have been disclosed in “Highly directional emission from few-micron-size elliptical microdisks”, Applied Physics Letters, 84, 6, ppg. 861-863 (2004), by Sun-Kyung Kim, et al. Such asymmetrical structures exhibit polarized light emission with the axis of polarization parallel to the major axis of the elliptical structure. The use of such asymmetrical structures to produce polarized light sources is a novel feature of the present invention.

The use of such etch structures further allows for a novel method of control of the emission intensity, through the use of Micro-Electro-Mechanical Systems (MEMS) devices to alter the degree of power coupling between the light power delivering waveguide and the emissive etch structure pixel. Such means have been disclosed in control of the power coupling to opto-electronic filters for telecommunications applications. In this case, the control function is used to tune the filter. Control over the power coupling is described in “A MEMS-Actuated Tunable Microdisk Resonator”, by Ming-Chang M. Lee and Ming C. Wu, paper MC3, 2003 IEEE/LEOS International Conference on Optical MEMS, 18-21 August 2003.

### SUMMARY OF THE INVENTION

In accordance with one aspect of the present invention there is provided a light source device comprising:

a. a support substrate;

b. a plurality of light emitting etch structures placed in a matrix on the support substrate forming an array of the light emitting etch structures;

c. a plurality of light waveguides positioned on the substrate such that each of the light emitting etch structures is associated with an electro-coupling region with respect with to one of the plurality of light waveguides;

d. a deflection mechanism for causing relative movement between a portion of at least one of the plurality of light waveguides and the associated light emitting etch structure for controlling when the light emitting etch structure is in the electro-coupling region; and

e. a light source associated with each of the plurality of light waveguides for transmitting a light along the plurality of light waveguides for providing power to excite each of the light emitting etch structures when positioned within the electro-coupling region.

In accordance with another aspect of the present invention there is provided a method for controlling visible light emitting from a light source device having a plurality of light emitting etch structures placed in a pattern forming a plurality of rows and columns and a plurality of wave light guides positioned so that each of the light emitting etch structures is positioned adjacent one of the plurality of wave light guides comprising the steps of:

a) providing a light source associated with each of the plurality of light waveguides for transmitting a light along the associated light waveguide;

b) providing deflection mechanism for causing relative movement between a portion of at least one of the plurality of light waveguides and the associated light emitting etch structure for controlling when the light emitting etch structure is in the electro-coupling region;

c) selectively controlling emission of visible light from the plurality of light emitting etch structures by controlling the deflection mechanism and light source such that when the light emitting etch structure in the electro-coupling region and a light is transmitted along the associated light waveguide the emission of visible light will occur.

In accordance with yet another aspect of the present invention there is provided a light source device comprising:

a. a support substrate; b. a plurality of light emitting etch structures placed in a matrix on the support substrate forming an array of the light emitting etch structures;

c. a plurality of light waveguides positioned on the substrate such that each of the light emitting etch structures is associated with an electro-coupling region with respect to one of the plurality of light waveguides;

d. a deflection mechanism for causing relative movement of at least one of the plurality of light waveguides with respect to the associated light emitting etch structure for controlling when the light emitting etch structure is in the electro-coupling region; and

e. a light source associated with each of the plurality of light waveguides for transmitting a light along the plurality of light waveguides for providing power to excite each of the light emitting etch structures when positioned within the electro-coupling region.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic top view of an optical flat panel light source made in accordance with the present invention;

FIGS. 2A, 2B and 2C are enlarged perspective schematic views of red light, green light and blue light emitting etch structures for a color light source made in accordance with the present invention;

FIG. 3 is a cross-section side view schematic of an optically pumped organic vertical cavity laser;

FIG. 4 is a cross-section side view schematic of an optically pumped organic vertical cavity laser with a periodically structured organic gain region;

FIG. 5 is an enlarged cross-sectional schematic view of the optical waveguide of FIGS. 1-2 showing the electrode geometry and electrostatic forces; FIGS. 6A, B, C and D illustrate enlarged cross-sectional schematic views of the optical waveguide of FIG. 2C taken along line 6-6 of FIG. 2C, in relationship to a MEMS device used to control the pixel intensity at various intensity positions and the light source etch structure;

FIGS. 6A, 6B, 6C and D are enlarged cross-sectional views of the light source taken along line 6-6 of FIG. 2C;

FIG. 7 is an enlarged cross-sectional view similar to FIGS. 6A, B, C, and D showing an alternative embodiment for the light-emissive etch structure;

FIG. 8 is enlarged cross-sectional view of the waveguide showing yet another embodiment for the light-emissive etch structure;

FIG. 9 is an enlarged cross-sectional schematic view of the of the waveguide showing an alternative arrangement of the light-emissive etch structure;

FIG. 10 is an enlarged partial perspective view of the light source of FIG. 1 showing a single asymmetrical etch structure and waveguide; and

FIG. 11 is an enlarged top schematic view showing an array of asymmetrical etch structures made in accordance with the present invention.

### DETAILED DESCRIPTION OF THE INVENTION

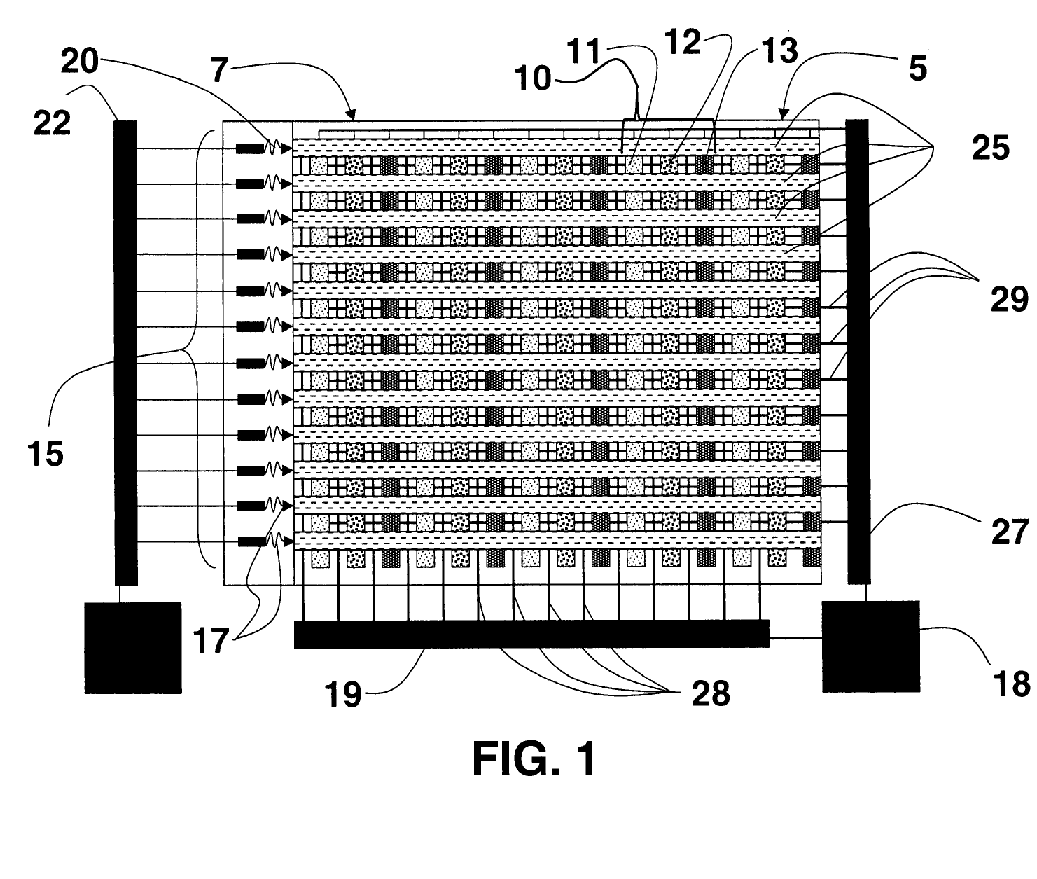

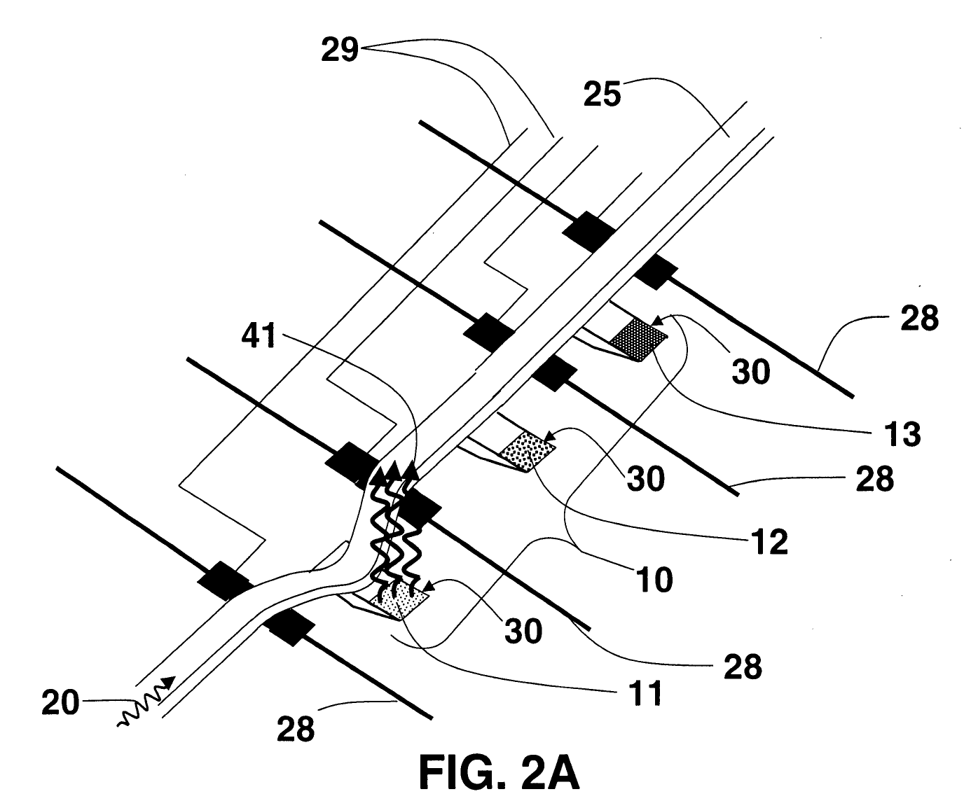

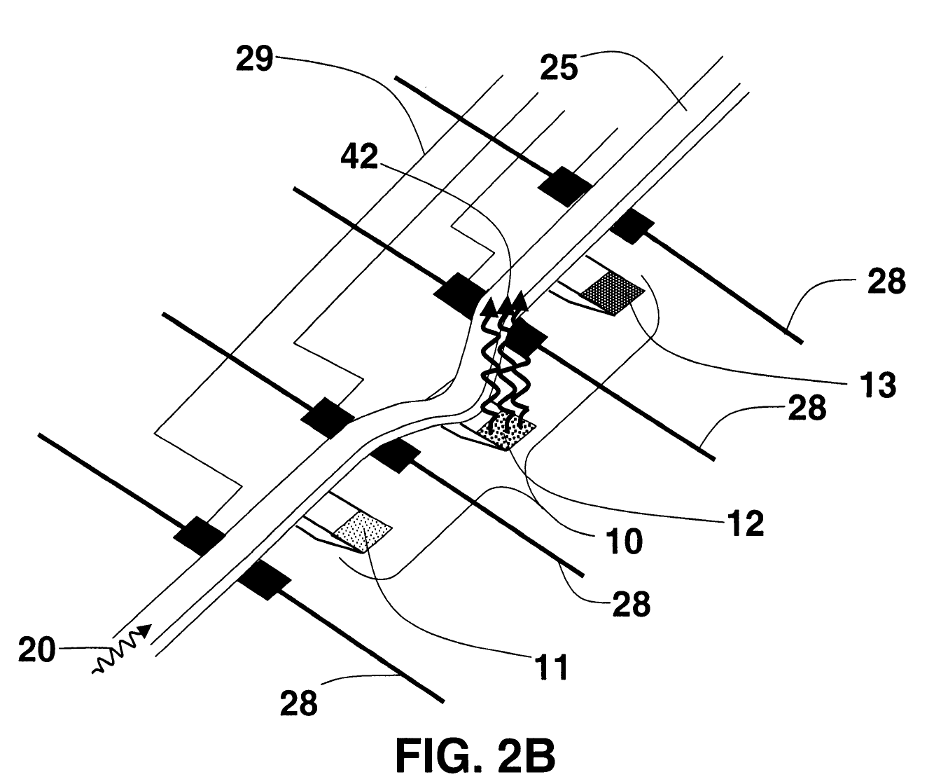

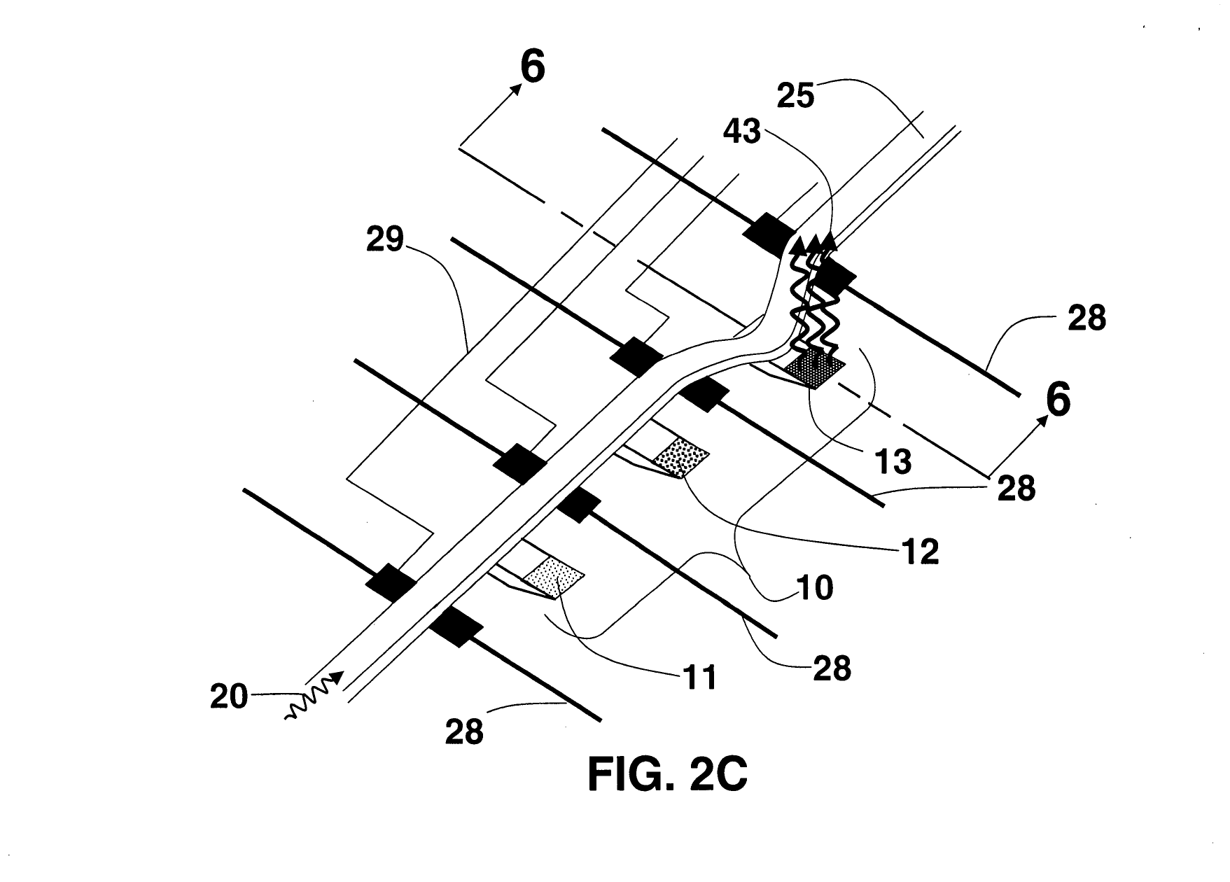

Referring to FIGS. 1, 2A, B, and C there is illustrated a photo-luminescent light source system 5 made in accordance with the present invention. The light source system 5 functions by converting excitation light to emitted, visible light. In the embodiment illustrated, for the production of visible light, each pixel group 10 in light source system 5 is comprised of one or more sub-pixels; for this embodiment the sub-pixels are comprised of a red sub-pixel 11, a green sub-pixel 12, and a blue sub-pixel 13. For clarity purposes, the pixel group 10 can refer to a single pixel, sub-pixel or group of sub-pixels. Colors other than red, green, and blue are caused by the admixture of these primary colors thus controlling the intensity of which the individual sub-pixels adjusts both the brightness and color of a pixel 10. Those skilled in the art understand that other primary color selections are possible and will lead to a full color light source and if desired a simple black and white display. This method and apparatus can also produce light wavelengths other than visible wavelengths, for example, infrared wavelengths. Color generation in the light source is a consequence of the mixing of multiple-wavelength light emissions by the viewer. This mixing is accomplished by the viewer's integration of spatially distinct, differing wavelength light emissions from separate sub-pixels that are below the spatial resolution limit of the viewer's eye. Typically a color light source has red, green, and blue separate and distinct sub-pixels, comprising a single variable color pixel. Monochrome light sources may be produced by the use of a single color pixel 10 or sub-pixel 11, 12, 13, or by constructing a single pixel capable of emitting “white” light. In one embodiment described in U.S. patent application Ser. No. 11/095,167 filed Mar. 31, 2005 entitled Visual Display With Electro-Optical Addressing Architecture by John P. Spoonhower et al., the spectral characteristics of a monochrome light source pixel will be determined by the choice of lumiphore or combination of lumiphores. White light generation can be accomplished through the use of multiple doping schemes for the light emitting etch structure 30 as described by Hatwar and Young in U.S. Pat. No. 6,727,644. Photo-luminescence is used to produce the separate wavelength emission from each pixel (or subpixel) element. The photo-luminescence may be a result of a number of physically different processes including multi-step, photonic up-conversion processes and the subsequent radiative emission process, direct optical absorption and the subsequent radiative emission process, or optical absorption followed by one or more energy transfer steps, and finally, the subsequent radiative emission process. Use of combinations of these processes may also be considered to be within the scope of this invention.

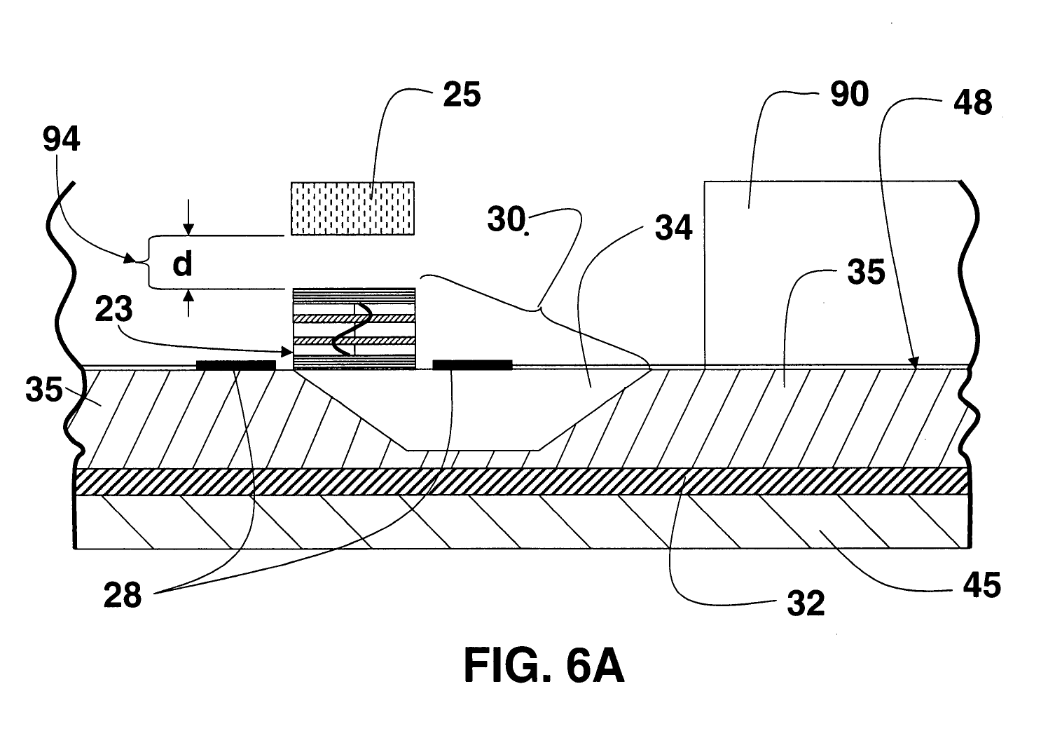

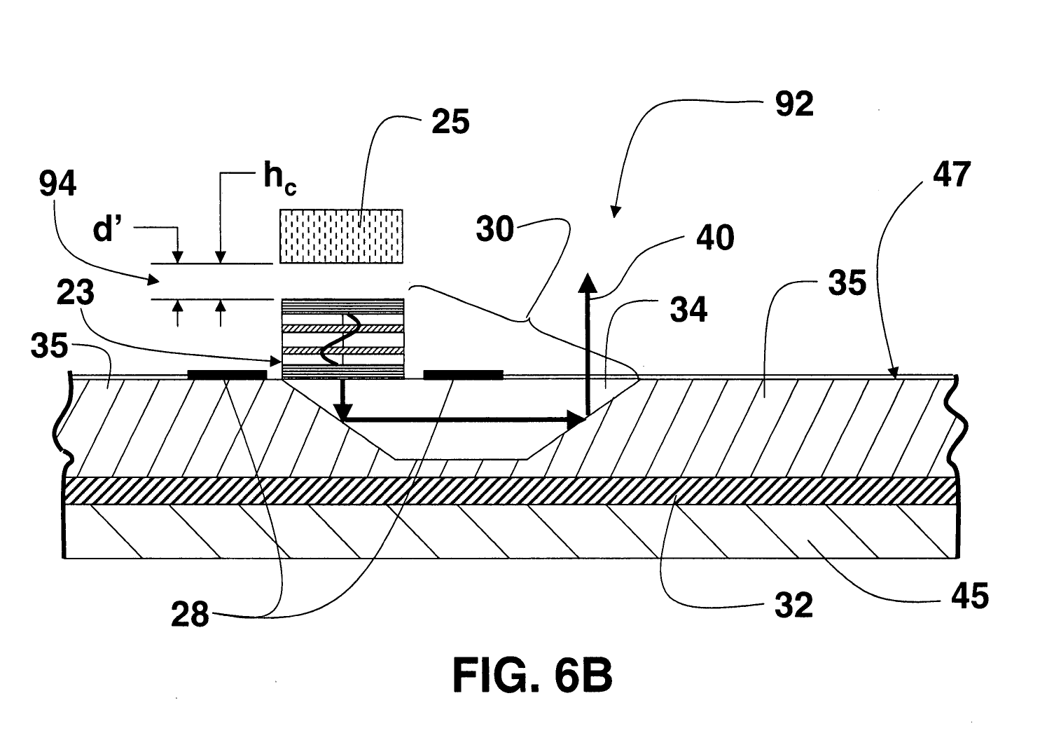

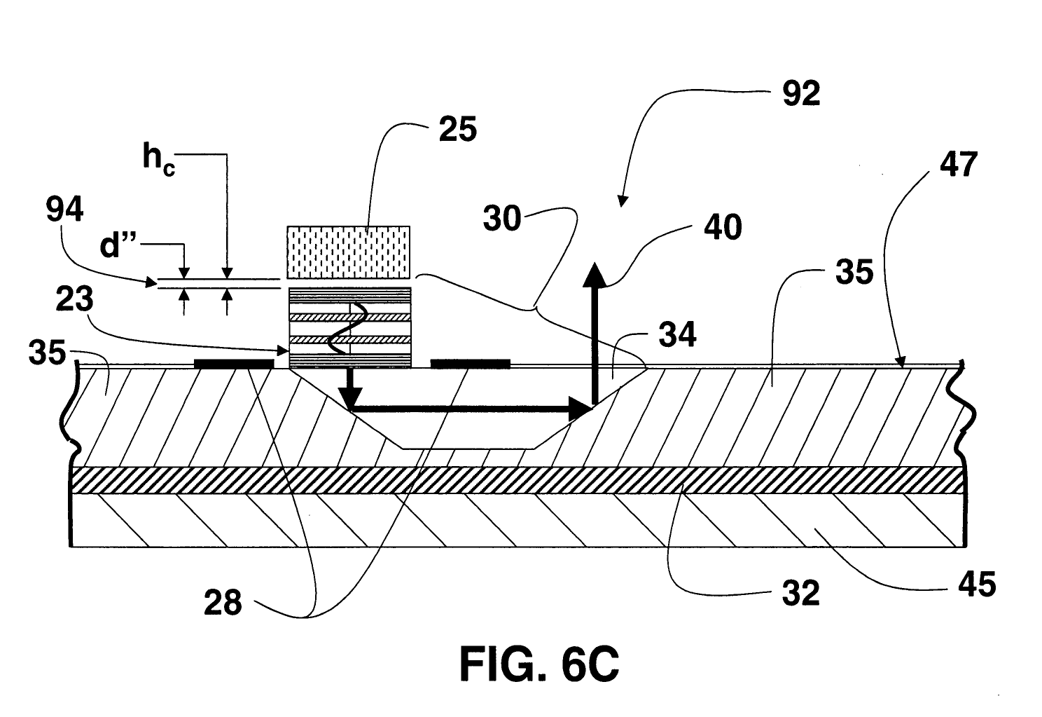

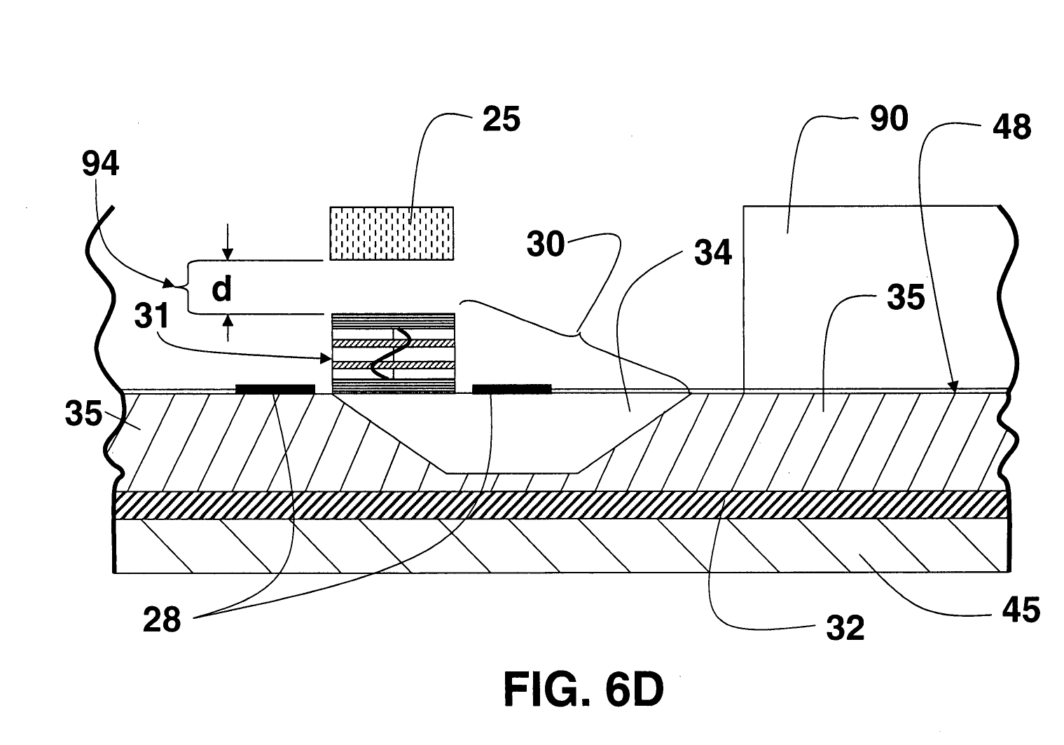

The light source system 5 contains an array 7 of light emitters providing for a matrix of pixels 10 each having a light emitting etch structure 30 (shown in FIGS. 2A, B, and C) located at each intersection of an optical row waveguide 25 and column electrodes 28. The light emitting etch structure 30 comprises a vertical cavity laser 23 and transmission region 34 shown in detail in FIGS. 6A, B and C, which form a pixel or sub-pixel 10. A power source 22 is used to activate the light source array 15. The light source array 15 provides optical power or light 20, used to excite the organic vertical cavity laser and/or photo-luminescent process in each pixel 10. Typical light source array elements 17 for the waveguides 25 may be diode lasers, light emitting diodes (LEDs), and the like. These may be coherent or incoherent light sources. These light source array elements 17 may be visible, ultraviolet, or infrared light sources depending upon the optical pumping requirements of the vertical cavity laser. There may be a one-to-one correspondence between the light source array element 17, and an optical row waveguide 25, or alternatively, there may be a single light source array element 17 multiplexed onto a number of optical row waveguides 25, through the use of an optical switch to redirect the light 20 output from the single light source array element 17.

A principal component of the photo-luminescent flat panel light source system 5 is the optical row waveguide 25, also known as a dielectric waveguide. Two key functions are provided by the waveguides 25. They confine and guide the optical power to the pixels 10. Several channel waveguide structures have been illustrated in U.S. Pat. No. 6,028,977. The optical waveguides must be restricted to TM and TE propagation modes. TM and TE mode means that optical field orientation is perpendicular to the direction of propagation. Dielectric waveguides confining the optical signal in this manner are called channel waveguides. The buried channel and embedded strip guides are applicable to the proposed light source technology. Each waveguide consists of a combination of cladding and core layer. These layers are fabricated on either a glass-based or polymer-based substrate. The core has a refractive index greater than the cladding layer. The core guides the optical power past the etch structure in the absence of power coupling. With the appropriate adjustment of the distance, as discussed later herein, between the optical row waveguide 25 and the light emitting etch structure 30, power is coupled into the light emitting etch structure 30. At the light emitting etch structure 30 the coupled optical light power drives the etch structure 30 active materials into a luminescent state. The waveguides 25 and etch structures 30 can be fabricated using a variety of conventional thin film techniques including microelectronic techniques like lithography. These methods are described, for example, in “High-Finesse Laterally Coupled Single-Mode Benzocyclobutene Microring Resonators” by W.-Y. Chen, R. Grover, T. A. Ibrahim, V. Van, W. N. Herman, and P.-T. Ho, IEEE Photonics Technology Letters, 16(2), p. 470. Other low-cost techniques for the fabrication of polymer waveguides can be used such as imprinting, and the like. Nano-imprinting methods have been described in “Polymer microring resonators fabricated by nanoimprint technique” by Chung-yen Chao and L. Jay Gao, J. Vac. Sci. Technol. B 20(6), November/December 2002, p. 2862. Photobleaching of polymeric materials as a fabrication method has been described by Joyce K. S. Poon, Yanyi Huang, George T. Paloczi, and Amnon Yariv, in “Wide-range tuning of polymer microring resonators by the photobleaching of CLD-1 chromophores” by, Optics Letters Vol. 29, No. 22, Nov. 15, 2004, p. 2584. This is an effective method for post fabrication treatment of optical micro-etch structures. A wide variety of polymer materials are useful in this and similar applications. These can include fluorinated polymers, polymethylacrylate, liquid crystal polymers, and conductive polymers such as polyethylene dioxythiophene, polyvinyl alcohol, and the like. These materials and additionally those in the class of liquid crystal polymers are suitable for this application (see Liquid Crystal Polymer (LCP) for MEMs: processes and applications, by X. Wang et. al., Journal of Micromechanics and Microengineering, 13 (2003) pages 628-633. This list is not intended to be all inclusive of the materials that may be employed for this application.

Excitation of the light emitting etch structure 30 (shown in FIGS. 2A, B, and C) is caused by the row waveguide 25 under the control of the column voltage source 18 and column electrodes 28 and the organic vertical cavity laser 23 (shown in FIG. 6A), and row electrodes 29, which causes the light emitting etch structure 30 to emit visible light. The excitation of the light emitting etch structure 30 is caused by the combination of the optical pumping action of the light 20 shown in FIG. 1 from a row light source array element 17 through the row waveguide 25, the controlling voltage to the column electrodes 28 by multiplex controller 19 from a column voltage source 18 and the organic vertical cavity laser 23. The excitation process is a coordinated row-column, electrically activated, optical pumping process called electro-optical addressing. Those skilled in the art know that the roles of the columns and rows are fully interchangeable without affecting the performance of the light source system 5.

In the present invention, one embodiment of the light emitting etch structure 30 is the organic vertical cavity laser device 23. The terminology describing organic vertical cavity laser devices 23 may be used interchangeably in a short hand fashion as “organic laser cavity devices.” Other embodiments of the light emitting etch structure 30 may be comprised of inorganic vertical cavity surface emitting lasers (VCSELs) 31 shown in FIG. 6D. As the preferred embodiment includes the use of organic vertical cavity laser device 23, their use will be described in greater detail.

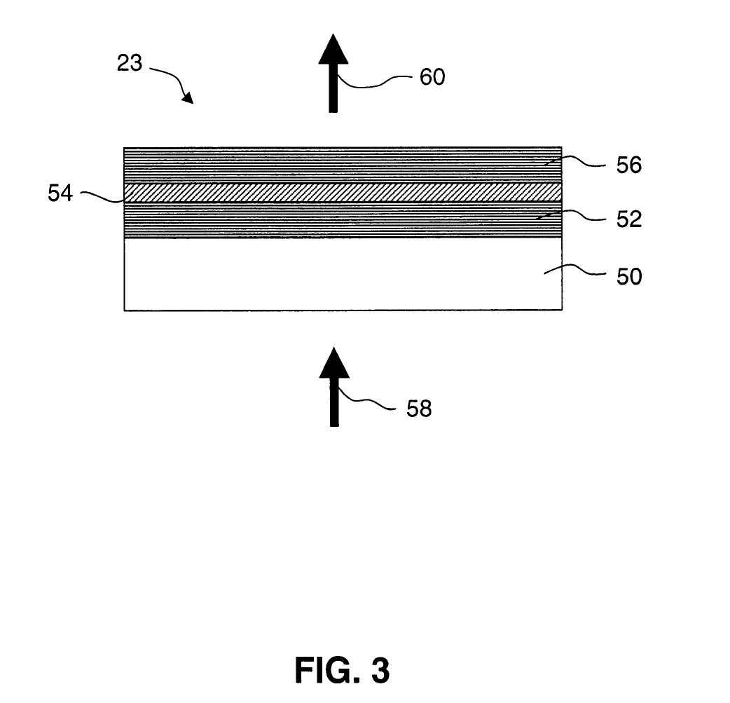

A schematic of an organic vertical cavity laser device 23 is shown in FIG. 3. The substrate 50 can either be light transmissive or opaque, depending on the intended direction of optical pumping or laser emission. Light transmissive substrates 50 may be transparent glass, sapphire, or other transparent flexible materials such as plastic. Alternatively, opaque substrates including, but not limited to, semiconductor material (e.g. silicon) or ceramic material may be used in the case where both optical pumping and emission occur through the same surface. On the substrate is deposited a bottom dielectric stack 52 followed by an organic active region 54. A top dielectric stack 56 is then deposited. A pump beam 58 optically pumps the vertical cavity organic laser device 23. The source of the pump beam 58 may be incoherent or coherent light, such as emission from diode lasers, infrared laser, light emitting diodes (LEDs), and the like. The choice of wavelength for the pump source depends upon the optical pumping requirements of the organic active region.

The preferred material for the organic active region 54 is a small-molecular weight organic host-dopant combination typically deposited by high-vacuum thermal evaporation. These host-dopant combinations are advantageous since they result in very small unpumped scattering/absorption losses for the gain media. It is preferred that the organic molecules be of small molecular weight since vacuum deposited materials can be deposited more uniformly than spin-coated polymeric materials. It is also preferred that the host materials used in the present invention are selected such that they have sufficient absorption of the pump beam 58 and are able to transfer a large percentage of their excitation energy to a dopant material via Förster energy transfer. Those skilled in the art are familiar with the concept of Förster energy transfer, which involves a radiationless transfer of energy between the host and dopant molecules. An example of a useful host-dopant combination for red-emitting lasers is aluminum tris(8-hydroxyquinoline) (Alq) as the host and [4-(dicyanomethylene)-2-t-butyl-6-(1,1,7,7-tetramethyljulolidyl-9-enyl)-4H-pyran] (DCJTB) as the dopant (at a volume fraction of 1%). Other host-dopant combinations can be used for other wavelength emissions. For example, in the green a useful combination is Alq as the host and [10-(2-benzothiazolyl)-2,3,6,7-tetrahydro-1,1,7,7-tetramethyl-1H,5H,11H-[1]Benzopyrano[6,7,8-ij]quinolizin-11-one] (C545T) as the dopant (at a volume fraction of 0.5%). Other organic gain region materials can be polymeric substances, e.g., polyphenylenevinylene derivatives, dialkoxy-polyphenylenevinylenes, poly-para-phenylene derivatives, and polyfluorene derivatives, as taught by Wolk et al. in commonly assigned U.S. Pat. No. 6,194,119 B1, issued Feb. 27, 2001, and referenced herein. It is the purpose of the organic active region 54 to receive transmitted pump beam light 58 and emit laser light.

The bottom and top dielectric stacks 52 and 56, respectively, are preferably deposited by conventional electron-beam deposition and can comprise alternating high index and low index dielectric materials, such as, TiO₂ and SiO₂, respectively. Other materials, such as Ta₂O₅ for the high index layers, could be used. The bottom dielectric stack 52 is deposited at a temperature of approximately 240° C. During the top dielectric stack 56 deposition process, the temperature is maintained at around 70° C. to avoid melting the organic active materials. In an alternative embodiment of the present invention, the top dielectric stack is replaced by the deposition of a reflective metal mirror layer. Typical metals are silver or aluminum, which have reflectivities in excess of 90%. In this alternative embodiment, both the pump beam 58 and the laser emission 60 would proceed through the substrate 50. Both the bottom dielectric stack 52 and the top dielectric stack 56 are reflective to laser light over a predetermined range of wavelengths, in accordance with the desired emission wavelength of the laser cavity 23.

The use of a vertical microcavity with very high finesse allows a lasing transition at a very low threshold (below 0.1 W/cm² power density). This low threshold enables incoherent optical sources to be used for the pumping instead of the focused output of laser diodes, which is conventionally used in other laser systems. An example of a pump source is a UV LED, or an array of UV LEDs, e.g. from Cree (specifically, the XBRIGHT® 900 UltraViolet Power Chip ® LEDs). These sources emit light centered near 405 nm wavelength and are known to produce power densities on the order of 20 W/cm² in chip form. Thus, even taking into account limitations in utilization efficiency due to device packaging and the extended angular emission profile of the LEDs, the LED brightness is sufficient to pump the laser cavity at a level many times above the lasing threshold. The cavity properties can also be used to affect the angular distribution of the emitted light. This is especially important in display applications as this angular distribution determines the field of view of the display by a viewer.

Organic vertical cavity lasers open up a more viable route to output that spans the visible spectrum. Organic based gain materials have the properties of low un-pumped scattering/absorption losses and high quantum efficiencies. VCSEL based organic laser cavities can be optically pumped using an incoherent light source such as light emitting diodes (LED) with lasing power thresholds below 5W/centimetersquared.

One advantage of organic-based lasers is that since the gain material is typically amorphous, devices can be formed inexpensively when compared to lasers with gain materials that require a high degree of crystallinity. Lasers based on amorphous gain materials can be fabricated over large areas without regard to producing large regions of a single crystalline material and can be scaled to arbitrary size resulting in greater power output. Because of the amorphous nature, organic based lasers can be grown on a variety of substrates, thus, materials such as glass, flexible plastics and Si are possible supports for these devices.

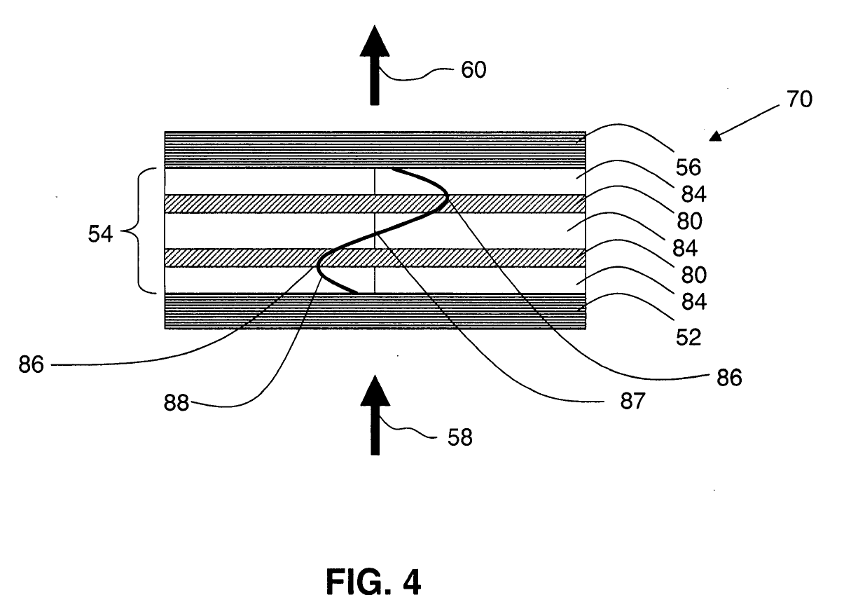

The efficiency of the laser is improved further using an active region design as depicted in FIG. 4 for the vertical cavity organic laser device 70. The organic active region 54 includes one or more periodic gain regions 80 and organic spacer layers 84 disposed on either side of the periodic gain regions 80 and arranged so that the periodic gain regions 80 are aligned with antinodes of the device's standing wave electromagnetic field. This is illustrated in FIG. 4 where the laser's standing electromagnetic field pattern 88 in the organic active region 54 is schematically drawn. Since stimulated emission is highest at the antinodes 86 and negligible at nodes 87 of the electromagnetic field, it is inherently advantageous to form the active region 54 as shown in FIG. 4. The organic spacer layers 84 do not undergo stimulated or spontaneous emission and largely do not absorb either the laser emission 60 or the pump beam 58 wavelengths. An example of a spacer layer 84 is the organic material 1,1-Bis-(4-bis(4-methyl-phenyl)-amino-phenyl)-cyclohexane (TAPC). TAPC works well as the spacer material since it largely does not absorb either the laser emission 60 or the pump beam 58 energy and, in addition, its refractive index is slightly lower than that of most organic host materials. This refractive index difference is useful since it helps in maximizing the overlap between the electromagnetic field antinodes and the periodic gain region(s) 80. As will be discussed below with reference to the present invention, employing periodic gain region(s) 80 instead of a bulk gain region results in higher power conversion efficiencies and a significant reduction of the unwanted spontaneous emission. The placement of the periodic gain region(s) 80 is determined by using the standard matrix method of optics (Corzine et al. IEEE Journal of Quantum Electronics, Volume 25, No. 6, June 1989). To get good results, the thicknesses of each of the periodic gain region(s) 80 need to be at or below 50 nm in order to avoid unwanted spontaneous emission. The design of the organic vertical cavity laser is described in U.S. Patent Application Publication No. 2004/0223525 A1, by Keith Kahen, filed Nov. 11, 2004, which is here incorporated by reference in its entirety.

Now referring back to FIG. 2A, electro-optical addressing is defined as a method for controlling an array 7 of light emitting etch structures 30 that form the optical flat panel light source 5 (see FIG. 1). In FIG. 2A, a pixel 10 comprised of three sub-pixels, 11, 12, and 13 is shown. In electro-optical addressing, the selection of a particular pixel that appears to be light emitting is accomplished by the specific combination of excitation of light in a particular optical row waveguide 25, the voltage applied to a particular set of column electrodes 28.

The light emitting etch structure 30 is excited into a photo-luminescent state through the absorption of light 20 as a result of the close proximity to the row waveguides 25. In the embodiment illustrated in FIGS. 6A, B and C the light emitting etch structure 30 includes an organic vertical cavity laser 23. The physics of the coupling of energy between the organic vertical cavity laser 23 and the optical row waveguide 25 is well known in the art. It is known to depend critically upon the optical path length between the row waveguide 25 and the light emitting organic vertical cavity laser 23; it can therefore be controlled by the distance d, (shown in FIGS. 6A, B and C) separating the two structures. The invention disclosed herein makes use of control of the distance parameter via a MEMS device to control the energy coupling, and thus affect the intensity of light generated in the pixel 10. Reducing the distance d increases the brightness of the light emitting from the organic vertical cavity laser 23.

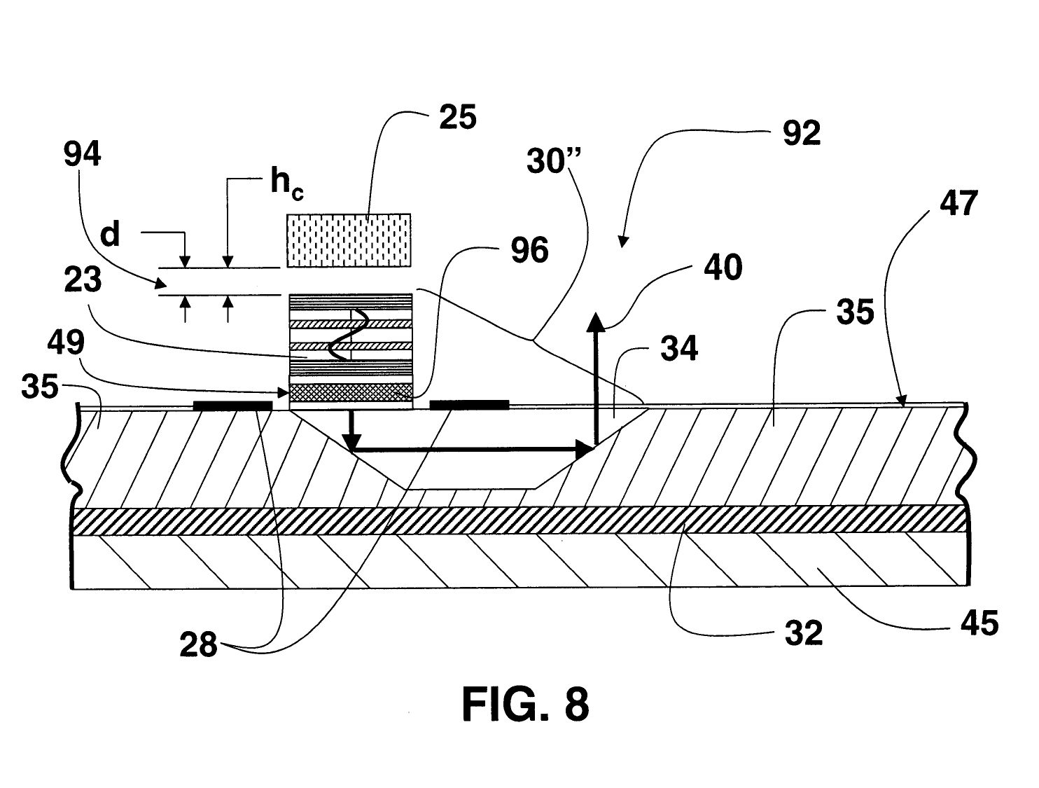

Electro-optical addressing employs the optical row waveguide 25 to deliver light 20 to a selected light emitting etch structure 30. The light emitting etch structure 30 is the basic building block of the light source 5. Referring again to FIGS. 2A, 2B, and 2C, an enlarged top view of a red light 41, green light 42 and blue light 43 light emitting etch structure 30 respectively, is illustrated respectively in these figures. Using the red light 41, green light 42 and blue light 43 light emitting etch structures to create red 11, green 12, and blue 13 pixels, a full color optical flat panel light source 5 can be formed. The wavelength of the emission of the red 41, green 42 and blue 43 light is controlled either by the type of fluorophore 96 (see FIG. 8) used in forming the light emitting etch structures 30 in layer 49, or by the wavelength of light emitted by the organic vertical cavity laser 23. Selection of a particular pixel 10 or sub-pixel (11-13) is based upon the use of a MEMS device to alter the distance and affect the degree of power transfer of light 20 to the organic vertical cavity laser 23. Note that in each instance, light 20 (See FIGS. 2A, B and C) is directed within an appropriate optical row waveguide 25 to excite a particular light emitting etch structure 30. Through the combination of excitation of a specific optical row waveguide with light 20 and excitation of a specific MEMS device, controlled by the column electrodes 28, a particular pixel 10 (subpixel) is excited.

Integrated semiconductor waveguide optics and microcavities have raised considerable interest for a wide range of applications, particularly for telecommunications applications. The invention disclosed herein applies this technology to electronic light sources. As stated previously, the energy exchange in the light emitting etch structure 30 is strongly dependent on the spatial distance d between the waveguide 25 and the organic vertical cavity laser 23. Controlling the distance between waveguides and microcavities 23 is a practical method to manipulate the power coupling and hence the brightness of a pixel 10 or sub-pixel (11-13).

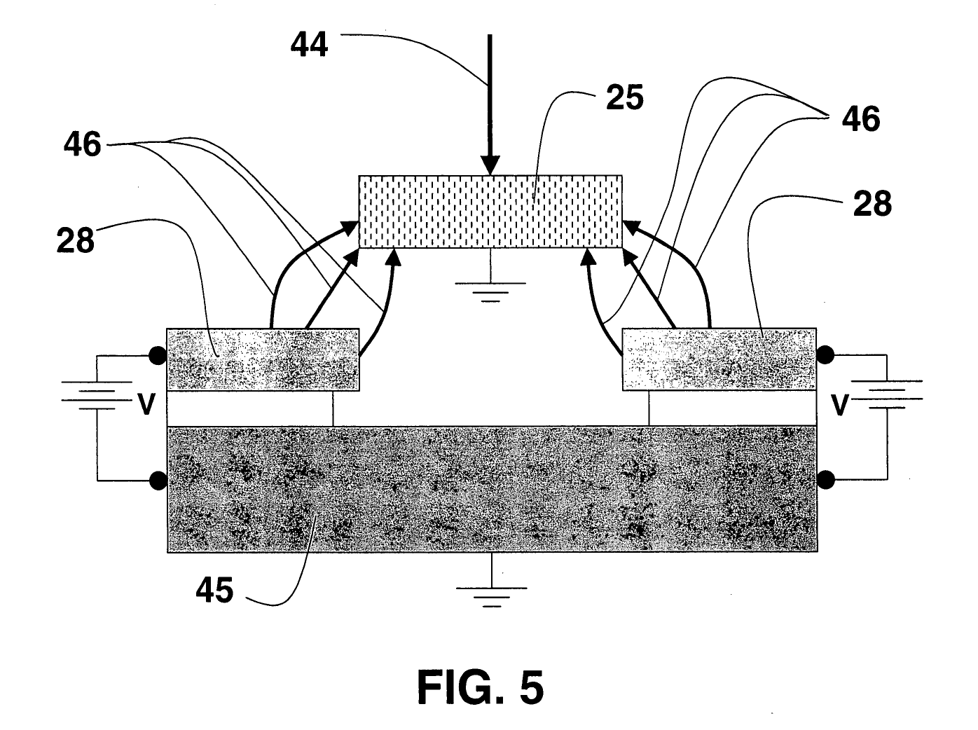

A MEMS device structure for affecting the distance d between the waveguide 25 and the light emitting etch structure 30 is shown in FIG. 5. FIG. 5 is an enlarged cross-sectional view of the optical waveguide showing the electrode geometry, field lines 46, and resulting downward electrostatic force 44 for affecting the power coupling change. MEMS actuators using electrostatic forces in this instance, move waveguide 25 to change the distance d, shown in FIG. 6A between an etch structure and the optical row waveguide 25, resulting in a wide tunable range of power coupling ratio by several orders of magnitude which is difficult to achieve by other methods. Based on this mechanism, the micro-disk/waveguide system can be dynamically operated in the under-coupled, critically-coupled and over-coupled condition.

The light source substrate or support 45 as shown in FIGS. 6A, B, and C can be constructed of either a silicon, glass or a polymer-based substrate material. A number of glass and polymer substrate materials are either commercially available or readily fabricated for this application. Such glass materials include: silicates, germanium oxide, zirconium fluoride, barium fluoride, strontium fluoride, lithium fluoride, and yttrium aluminum garnet glasses. A schematic of an enlarged cross-sectional view of the light source 5 taken along the line 6-6 of FIG. 2C is shown in FIG. 6A. On a substrate 45 is formed a layer 35 containing the optical row waveguide 25 and the light emitting etch structure 30. For such a buried-channel waveguide structure it is imperative that the refractive index of optical row waveguide 25 (the core) be greater than the surrounding materials, in this instance the layer 35. The layer 35 acts as the cladding region in this embodiment. An optional layer 32 is shown; this may be of a relatively lower index material in order to better optically isolate the optical row waveguide 25. A top layer 90 is provided on the top surface 48 of layer 35 for protection of the underlying structures. In the case of FIGS. 6B and 6C the entire structure is shown surrounded by air 92.

Again referring to FIG. 6A, by varying the gap spacing or distance d, between the waveguide 25 and the organic vertical cavity laser 23 by simply a fraction of a micron leads to a very significant change in the power transfer to the organic vertical cavity laser 23 from the optical row waveguide 25. FIG. 6A is an enlarged perspective view of the light source of FIG. 1 showing a light emitting etch structure 30, optical waveguide 25, and electrodes 28. As shown in FIG. 6A, a suspended waveguide is placed in close proximity to the organic vertical cavity laser 23. The initial gap (not shown) (˜1 μm wide) is large so there is no coupling between the waveguide and the etch structure. Referring to FIG. 6A, the suspended optical row waveguide 25 can be pulled towards the micro-etch structure by the electrostatic gap-closing actuators, the electrodes 28. Therefore, the coupling coefficient can be varied by applied voltage. For high index-contrast waveguides, the coupling coefficient is very sensitive to the critical distance. 1-um displacement can achieve a wide tuning range in power coupling ratio, which is more than five orders of magnitude. In FIG. 6C the optical waveguide 25 is shown displaced downward so as to affect a maximum power transfer to the organic vertical cavity laser 23.

FIGS. 6A, B and C are enlarged cross-sectional views of the light source taken along line 6-6 of FIG. 2C, which show the location of a MEMS device used to control the pixel intensity. Referring to FIG. 6A, the light emitting etch structure 30 is comprised of a light emitting portion, in this instance the organic vertical cavity laser 23, and the optical transmission region 34. The optical transmission region can be formed in a number of ways. For example, the optical transmission region 34 could be simply an etched region of layer 35 with reflective interfaces for the emitted light from the organic vertical cavity laser 23. High reflectivity interfaces can be formed by having high index of refraction contrast between layer 35 and optical transmission region 34. For example, optical medium in the transmission region 34 could be air 92 with metal films deposited to enhance the optical reflection. Alternatively, the optical transmission region 34 could be composed of a material with an index of refraction higher than layer 35. In this case the reflectivity at the interfaces shown in the subsequent figures would be a result of total internal reflection. The organic vertical cavity laser 23 is shown with a periodic internal structure but it to be understood that may such structures are considered within the scope of this invention. Additionally, although the preferred embodiment of this invention uses an organic vertical cavity laser 23, other semiconductor materials can be employed in like manner. Alternatively inorganic VCSEL 31 devices (See FIG. 6D) could be used as part of the etch structure 30. The area surrounding the optical row waveguide 25 and the light emitting etch structure 30 has been etched back to expose the top surfaces 47 to air 92 in FIGS. 6B and C. The optical row waveguide 25 is aligned to the edge of the light emitting organic vertical cavity laser 23 and vertically displaced to preclude a high degree of coupling. The organic vertical cavity laser 23 emits no light under these conditions. The waveguide 25 is electrically grounded and actuated by a pair of electrodes 28 at the two ends, which forms an electro-coupling region 94. Due to the electrostatic force, the waveguide is pulled downward toward the light emitting etch structure 30, resulting in the decreased gap-spacing d. The optical row waveguide 25 is shown in the rest position d in FIG. 6A. In FIG. 6A, the distance between the optical row waveguide 25 and the light emitting organic vertical cavity laser 23 is large; coupling of light into the light emitting etch structure 30 is precluded and there is no light emission from the pixel. Initially, in the absence of the application of the control voltage, the optical row waveguide 25 is separated from the light emitting etch structure by a distance significantly greater than the critical distance “h_{c}” (see FIG. 6A) and hence there is no light emission from the organic vertical cavity laser 23 light emitting etch structure 30. In FIG. 6B, the vertical distance d′ is shown where there exists a degree of coupling between the optical row waveguide 25 and the light emitting organic vertical cavity laser 23, and hence light emission from the pixel occurs. By varying the distance d′, the intensity of the light emission from the pixel can be varied in a controllable manner. In FIG. 6C, the distance d″ is shown that corresponds to the displacement of the optical row waveguide 25 necessary to place the optical row waveguide 25 at the critical coupling distance h_{c} and thereby optimize power coupling. This configuration will produce the maximum emitted light intensity from the pixel. The optical row waveguide can be fabricated from silicon appropriately doped to provide electrical conductivity. Alternatively, the optical row waveguide can be fabricated from other optically transparent conductive materials such as polymers that meet the optical index of refraction requirement disclosed above.

In the embodiment shown in FIG. 6C, the light emitting organic vertical cavity laser 23 is shown spaced the critical distance h_{c} from the optical row waveguide 25. Excitation light 20 produces light emission from organic vertical cavity laser 23 of the light emitting etch structure 30, which causes the light emitting etch structure to transmit light and become visible to a viewer.

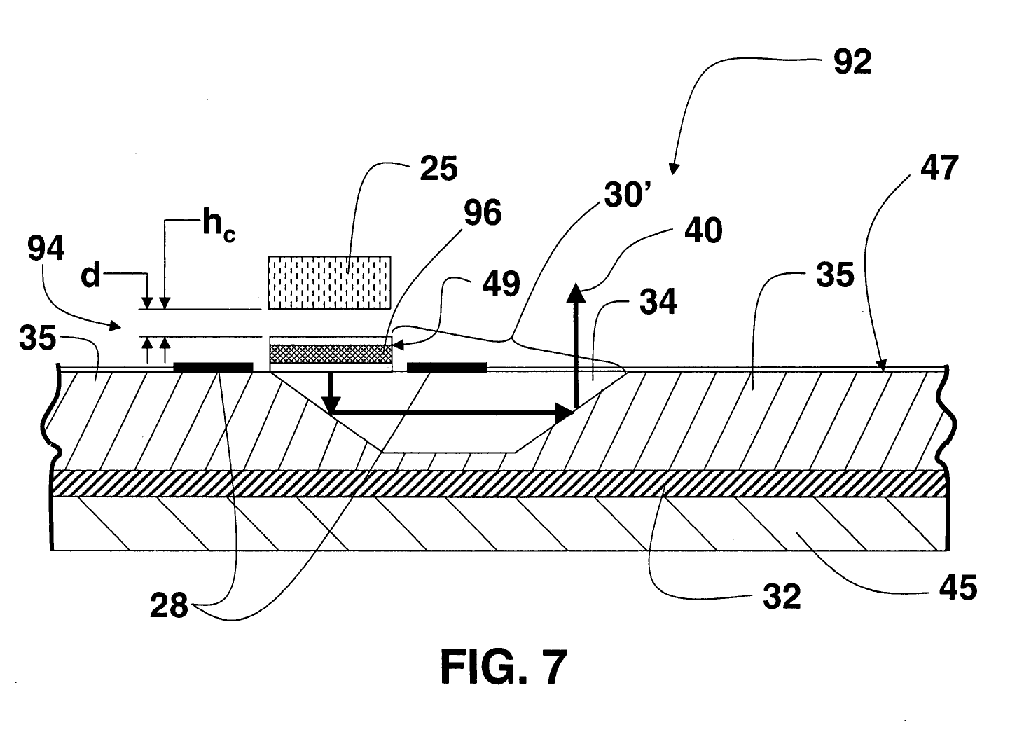

FIG. 7 is an enlarged cross-sectional view of the etch structure elements showing an alternative embodiment for the light emissive etch structure 30′. In the embodiment shown a light emitting layer 49 is placed within the light emitting etch structure 30′. This layer 49 contains lumiphores 96 that absorb the pump or excitation light 20 and via the luminescence processes discussed above, produce the light directed to the light source. Light-emitting species of lumiphores 96 can include various material species, including fluorophores or phosphors including up-converting phosphors. The selection of a particular light emitting species will primarily determine the emission spectrum of a particular light emitting etch structure 30′. These lumiphores 96 (fluorophores or phosphors) may be inorganic materials or organic materials. The light emitting etch structure 30′ can include a combination of material species that cause it to respond to the electro-optic addressing by emitting visible radiation. These may include the rare earth and transition metal ions either singly or in combinations, organic dyes, light emitting polymers, or materials used to make Organic Light Emitting Diodes (OLEDs). Additionally, lumiphores can include such highly luminescent materials such as inorganic chemical quantum dots, such as nano-sized CdSe or CdTe, or organic nano-structured materials such as the fluorescent silica-based nanoparticles disclosed in U.S. Patent Application Publication US 2004/0101822 by Wiesner and Ow. The use of such materials is known in the art to produce highly luminescent materials. Single rare earth dopants that can be used are erbium (Er), holmium, thulium, praseodymium, neodymium (Nd) and ytterbium. Some rare-earth co-dopant combinations include ytterbium: erbium, ytterbium: thulium and thulium: praseodymium. Single transition metal dopants are chromium (Cr), thallium (Tl), manganese (Mn), vanadium (V), iron (Fe), cobalt (Co) and nickel (Ni). Other transition metal co-dopant combinations include Cr: Nd and Cr: Er. The up-conversion process has been demonstrated in several transparent fluoride crystals and glasses doped with a variety of rare-earth ions. In particular, CaF₂ doped with Er³⁺. In this instance, infrared up-conversion of the Er3+ ion can be caused to emit two different colors: red (650 nm) and green (550 nm). The emission of the system is spontaneous and isotropic with respect to direction. Organic fluorophores can include dyes such as Rhodamine B, and the like. Such dyes are well known having been applied to the fabrication of organic dye lasers for many years. It is preferred that the host materials used in the present invention are selected such that they have sufficient absorption of the excitation light 20 and are able to transfer a large percentage of their excitation energy to a dopant material via Förster energy transfer. Those skilled in the art are familiar with the concept of Förster energy transfer, which involves a radiationless transfer of energy between the host and dopant molecules. An example of a useful host-dopant combination for red-emitting lasers is aluminum tris(8-hydroxyquinoline) (Alq) as the host and [4-(dicyanomethylene)-2-t-butyl-6-(1,1,7,7-tetramethyljulolidyl-9-enyl)-4H-pyran] (DCJTB) as the dopant (at a volume fraction of 1%). Other host-dopant combinations can be used for other wavelength emissions. For example, in the green a useful combination is Alq as the host and [10-(2-benzothiazolyl)-2,3,6,7-tetrahydro-1,1,7,7-tetramethyl-1H,5H,11H-[1]Benzopyrano[6,7,8-ij]quinolizin-11-one] (C545T) as the dopant (at a volume fraction of 0.5%). Other organic light emitting materials can be polymeric substances, e.g., polyphenylenevinylene derivatives, dialkoxy-polyphenylenevinylenes, poly-para-phenylene derivatives, and polyfluorene derivatives, as taught by Wolk et al. in commonly assigned U.S. Pat. No. 6,194,119 B1 and references therein.

The wavelength of the light produced in the emitting layer 49 is determined by the material composition as previously disclosed. The light emitting layer 49 may be formed on the top surface of the light emitting etch structure 30′ as well as placed within the internal structure of the light emitting layer 49.

FIG. 8 is an enlarged cross-sectional view of the etch structure elements showing an alternative embodiment for the light emissive etch structure 30″. In this embodiment the light emitted from the vertical cavity laser 23 excites the lumiphores 96, which are shown uniformly distributed within the light emitting layer 49.

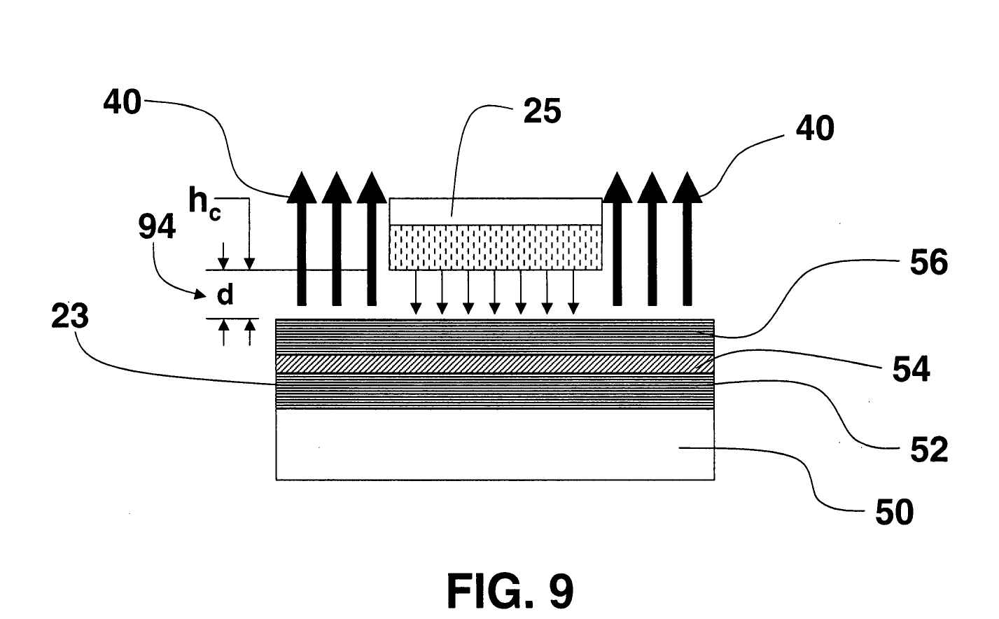

FIG. 9 is an enlarged cross-sectional view showing yet another embodiment of the light-emissive portion with the waveguide 25 and vertical cavity laser 23 in a different arrangement. In this case, the substrate 50 or the bottom dielectric stack 52 of the organic vertical cavity laser 23 is made highly reflective to light at both the optical excitation wavelength and the lasing wavelength. This enables the cavity with suitable design of the top dielectric stack 54 to emit light in a reflective mode. As in earlier embodiments, the distance d between the optical waveguide 25 and the organic vertical cavity laser 23 will control the intensity of the light 40 emission. When the distance d equals the critical distance hc, the maximum intensity of light will be emitted. A number of different arrangements have been demonstrated for the etch structure element, the waveguide 25, organic vertical cavity laser 23, lumiphores 96 and the combination of these elements. The coupling of optical power into such structures is well known to those skilled in the art. The use of all such structures as light emitting portions of the etch structures 30, 30′ and 30″ are considered within the scope of this invention.

It is well known in the art of vertical cavity lasers that VCSELs offer the opportunity for emitted light polarization control. Geometrically symmetric VCSELs possess degenerate transverse modes with orthogonal polarization states. Consequently, it is necessary to break the symmetry of the VCSELS in order to force a particular mode of oscillation, and thus a particular polarization state. Such polarized output devices use an asymmetric geometric element to produce polarized light. In pending U.S. Publication No. 2004/0190584 by John P. Spoonhower et al., titled “Organic Fiber Laser System And Method,” which is incorporated herein by reference, means for producing a polarized light output from an organic vertical cavity laser are disclosed. The asymmetric geometric elements may be a vertical cavity laser 23 with asymmetric lateral confinement provided by reflectivity modulation of the cavity mirrors. In “Vertical-Cavity Surface-Emitting Lasers,” by Carl W. Wilmsen et al., Cambridge University Press, 1999, for example, a specific control of polarization mode by the use of spatially asymmetric vertical cavity laser array elements, otherwise referred to herein as asymmetric geometric elements, is described. One mechanism for producing a laser output with stable single polarization is to reduce the size of the vertical cavity laser device in one dimension by means of asymmetric lateral confinement. For example, a rectangular vertical cavity laser device with dimensions 6×3.5 μm, exhibits increased diffraction loss of fundamental-mode emission by reducing its size from a fully symmetric device geometry (6×6 μM). This increased diffraction loss of fundamental-mode emission leads to pinning of the polarization laser emission direction. Likewise, Marko Loncar et al. in “Low-Threshold Photonic Crystal Laser,” Applied Physics Letters, Vol. 81, No. 15, Oct. 7, 2002, pages 2680-2682 describe the production of polarized laser light through the use of such photonic band-gap structures.

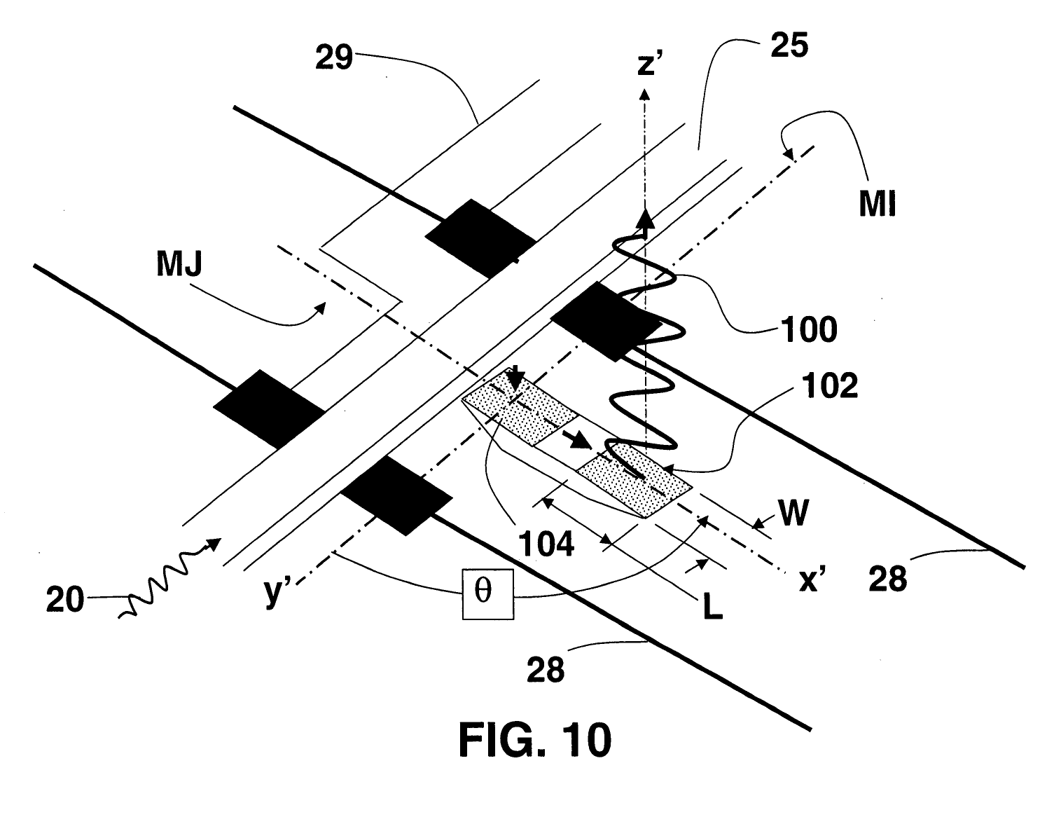

In the embodiment shown in FIG. 10, an asymmetrical light emitting etch structure 102 is shown spaced a distance from the optical row waveguide 25. Excitation light 20 is transmitted within the optical waveguide 25 and using the methods disclosed above can be coupled as pump light into an asymmetrical vertical cavity laser 104, which causes the asymmetrical light emitting etch structure to produce and transmit polarized light 100.

A polarized light wave 100 is depicted in FIG. 10, having been emitted from the asymmetrical light emitting etch structure 102. The asymmetrical light emitting etch structure 102 is made asymmetrical by having a length “L” which is greater then the width “W”. Only one of many such polarized light waves 100 is depicted for clarity. The polarized light wave 100 is shown propagating in the z′ direction; an x′, y′, z′ right hand coordinate system is shown in FIG. 10 for reference purposes. The emitted polarized light wave 100 is shown with its polarization direction shown as in the x′-z′ plane, which is parallel to the major axis MJ. Other emitted polarized light waves 100 would be similarly polarized from the asymmetrical light emitting etch structure 102, having their polarization axes parallel to the major axis of the asymmetrical light emitting etch structure 102. In the embodiment illustrated the major axis MJ is orientated at an angle θ of 90 degrees with respect to the waveguide 25 and the minor axis MI is orientated substantially parallel to the waveguide 25. Other polarization directions may be produced by changing the orientation of the asymmetrical vertical cavity laser 104.

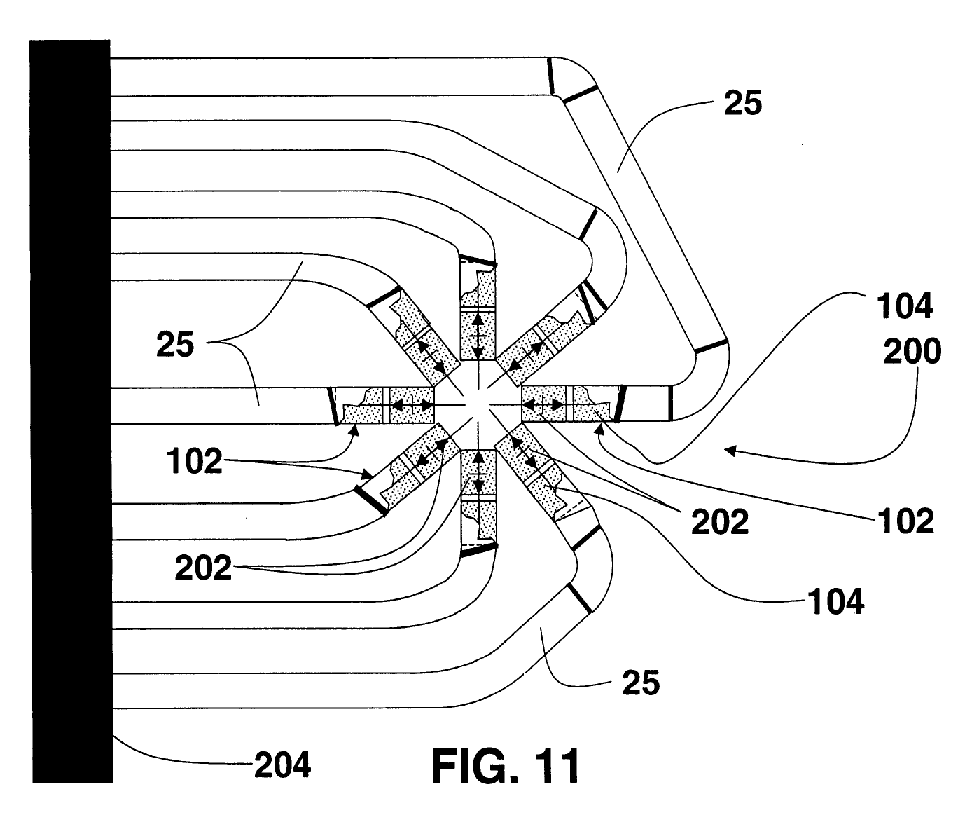

FIG. 11 is an enlarged top plan view showing a polarized light source 200 comprising an array of asymmetrical etch structures 202 made in accordance with the present invention. The top plan view shows an array of asymmetrical light emitting etch structures 202 each coupled to an optical waveguide 25. It is assumed that the light coupling between the optical waveguide 25 and the asymmetrical light emitting etch structures 202 is fixed with an optimum coupling between these elements. The MEMs array controller 204 incorporates the various MEMs structures disclosed above for each of the optical waveguide 25. This switch array combined with optical delay lines as cited in the reference below comprise the controller 204. This element enables precise control of the intensity of pump light transmitted as pump light 20 to each of the asymmetrical light emitting etch structures 202. By controlling the intensity and the relative timing or phase of the pump light 20 transmitted to each of the asymmetrical light emitting etch structures 202 arbitrary light intensity and relative phase can be imparted to the light emitted by each of the asymmetrical light emitting etch structures 202. Okayama in Optical review 10, 4, p 283-286 (2003) discloses the use of such array structures to produce a mechanism for steering a beam of light. Light from each of the asymmetrical light emitting etch structures 202 will be combined in the far field at distances large compared to the size of the array. This combination can be used to modify the propagation angle for the far-field beam. Alternatively, this type of structure could be used to control the polarization of the beam. This structure could be used for example to produce circularly polarized light. Other polarized states such as linear, elliptical etc. can be generated as desired. This control can be accomplished by modifying the relative phase and excitation timing of the optical power sent to each of the individual asymmetrical light emitting etch structures 202 through the optical waveguides 25. The controller 204 controls the distribution of optical power in the manner described above. In the production of circularly polarized light for example, the controller 204 would sequentially deliver optical to each of the eight asymmetrical light emitting etch structures 202 depicted in FIG. 11 in a counter-clockwise sequential pattern. This would generate a circularly polarized beam with one rotational sense. Alternatively, the opposite rotational polarization sense could be produced by a clockwise sequential deliver of optical power through the optical waveguide 25 to the asymmetrical light emitting etch structures 202.

Many other such variations are possible and considered within the scope of this invention, the present invention being defined by the claims set forth herein

### PARTS LIST

5 light source
7 array
10 pixel group
11 red sub-pixel
12 green sub-pixel
13 blue sub-pixel
15 light source array
17 light source array element
18 column voltage source
19 multiplex controller light
20 power source
22 organic vertical cavity laser
23 row waveguide
25 row voltage source
27 column electrodes
28 row electrodes
30, 30′, 30″ light emitting etch structure
31 vertical cavity surface emitting laser
32 optional layer
34 transmission region
35 layer
39 bottom surface of light emitting etch structure
41 red light
42 green light
43 blue light
44 force
45 support
46 field lines
47 top surface
48 top surface
49 emitting layer
50 substrate
52 bottom dielectric stack
54 organic active region
56 top dielectric stack
58 pump beam
60 laser emission
70 vertical cavity organic laser device
80 periodic gain regions
84 spacer layer
86 antinodes
87 nodes
88 field pattern
90 top layer
92 air
94 electro-coupling region
96 lumiphores
100 polarized light waves
102 asymmetrical light emitting etch structure
104 asymmetrical vertical cavity laser
200 polarized light source
202 asymmetrical etch structures
204 MEMs array controller

What is claimed is:

1. A light source device comprising:
a. a support substrate;
b. a plurality of light emitting etch structures placed in a matrix on said support substrate forming an array of said light emitting etch structures;
c. a plurality of light waveguides positioned on said substrate such that each of said light emitting etch structures is associated with an electro-coupling region with respect with to one of said plurality of light waveguides;
d. a deflection mechanism for causing relative movement between a portion of at least one of said plurality of light waveguides and said associated light emitting etch structure for controlling when said light emitting etch structure is in said electro-coupling region; and
e. a light source associated with each of said plurality of light waveguides for transmitting a light along said plurality of light waveguides for providing power to excite each of said light emitting etch structures when positioned within said electro-coupling region.

2. A light source device according to claim 1 wherein said light source comprises an infrared light source.

3. A light source device according to claim 1 wherein said light source comprises an ultra violet light source.

4. A light source device according to claim 1 wherein said light source comprises a visible light source.

5. A light source device according to claim 2 wherein said infrared light source comprises a laser infrared light source.

6. A light source device according to claim 1 wherein said light source comprises a light emitting diode.

7. A light source device according to claim 1 wherein said light source may comprise a coherent or incoherent light source.

8. A light source device according to claim 6 wherein said light emitting etch structures comprises an upconverting phosphor.

9. A light source device according to claim 1 wherein each of said plurality of light emitting etch structures comprise a light emitting layer made of a lumiphore.

10. A light source device according to claim 9 wherein said lumiphore is selected from any of the following:
organic dyes, organic dye aggregates, light emitting polymers, organic fluorophores, organic host-dopant combination materials, organic phosphors, inorganic phosphors, upconverting phosphors, organic and inorganic nano-materials such as chemical quantum dots, semiconducting materials such as GaAs, OLED materials.

11. A light source device according to claim 1 wherein said plurality of light emitting etch structures comprise inorganic vertical cavity surface emitting lasers.

12. A light source device according to claim 1 wherein an overcoat is provided over said plurality of light emitting etch structures and light waveguides.

13. A light source device according to claim 1 wherein said deflection mechanism comprises at least one electrode provided for deflection of said portion of said waveguides.

14. A light source device according to claim 1 wherein said deflection mechanism comprises a pair of electrodes provided for deflection on said portion of said waveguides.

15. A light source device according to claim 1 wherein said deflection mechanism comprises a pair of electrodes disposed on both sides of at least one of light emitting etch structure and passing adjacent with at least one of said plurality of light waveguides whereby when a voltage is applied across said pair of electrodes a field is produced that causes said at least one waveguide to move into said electro-coupling region.

16. A light source device according to claim 12 wherein a control mechanism is provided for controlling the amount of said voltage across said pair of electrodes for controlling the distance in which said at least one waveguide moves into said electro-coupling region so as to control the amount of emission from said associated light emitting etch structure.

17. A light source device according to claim 1 wherein said plurality of light emitting etch structures are grouped into sets wherein each of said leaky etch structures emit a different color.

18. A light source device according to claim 1 wherein said plurality of light emitting etch structures emit a polarized light.

19. A light source device according to claim 1 wherein said plurality of light emitting etch structures emit a polarized light in a predetermined direction.

20. A method for controlling visible light emitting from a light source device having a plurality of light emitting etch structures placed in a pattern forming a plurality of rows and columns and a plurality of wave light guides positioned so that each of said light emitting etch structures is positioned adjacent one of said plurality of wave light guides comprising the steps of:
a. providing a light source associated with each of said plurality of light waveguides for transmitting a light along said associated light waveguide;
b. providing deflection mechanism for causing relative movement between a portion of at least one of said plurality of light waveguides and said associated light emitting etch structure for controlling when said light emitting etch structure is in said electro-coupling region;
c. selectively controlling emission of visible light from said plurality of light emitting etch structures by controlling said deflection mechanism and light source such that when said light emitting etch structure in said electro-coupling region and a light is transmitted along said associated light waveguide said emission of visible light will occur.

21. The method according to claim 20 wherein deflection mechanism for causing relative movement comprises a pair of electrodes associated with each of said plurality of light emitting etch structures, further comprising the step of controlling the amount of relative movement by controlling the voltage applied across said pair of electrodes.

22. The method according to claim 20 wherein said light source comprises an infrared light source.

23. The method according to claim 20 wherein said infrared light source comprises a laser infrared light source.

24. The method according to claim 20 wherein said light source comprises a light emitting diode.

25. The method according to claim 20 wherein said deflection mechanism comprises at least one electrode provided for deflection of said portion of said waveguides.

26. The method according to claim 20 wherein said deflection mechanism comprises a pair of electrodes provided for deflection of said portion of said waveguides.

27. The method according to claim 20 wherein said deflection mechanism comprises a pair of electrodes disposed on both sides of at least one of said light emitting etch structure and passing adjacent with at least one of said plurality of light waveguides whereby when a voltage is applied across said pair of electrodes a field is produced that causes said at least one waveguide to move into said electro-coupling region.

28. The method according to claim 27 wherein a control mechanism is provided for controlling the amount of said voltage across said pair of electrodes for controlling the distance in which said at least one waveguide moves into said electro-coupling region so as to control the amount of emission from said associated light emitting etch structure.

29. The method according to claim 20 wherein said plurality of light emitting etch structure are grouped into sets wherein each of said etch structures emit a different color.

30. The method according to claim 20 wherein said light source comprises an infrared light source.

31. The method according to claim 29 wherein said infrared light source comprises a laser infrared light source.

32. The method according to claim 20 wherein said light source comprises a light emitting diode.

33. The method according to claim 20 wherein said plurality of light emitting etch structures provide a polarized light.

34. The method according to claim 33 further comprising the step of controlling the direction of said polarized light.

35. A light source device comprising:
a. a support substrate;
b. a plurality of light emitting etch structures placed in a matrix on said support substrate forming an array of said light emitting etch structures;
c. a plurality of light waveguides positioned on said substrate such that each of said light emitting etch structures is associated with an electro-coupling region with respect to one of said plurality of light waveguides;
d. a deflection mechanism for causing relative movement of at least one of said plurality of light waveguides with respect to said associated light emitting etch structure for controlling when said light emitting etch structure is in said electro-coupling region; and
e. a light source associated with each of said plurality of light waveguides for transmitting a light along said plurality of light waveguides for providing power to excite each of said light emitting etch structures when positioned within said electro-coupling region.

36. A light source device according to claim 35 wherein said light source comprises an infrared light source.

37. A light source device according to claim 35 wherein said light source comprises an ultra violet light source.

38. A light source device according to claim 35 wherein said light source comprises a visible light source.

39. A light source device according to claim 36 wherein said infrared light source comprises a laser infrared light source.

40. A light source device according to claim 35 wherein said light source comprises a light emitting diode.

41. A light source device according to claim 35 wherein said light source may comprise a coherent or incoherent light source.

42. A light source device according to claim 35 wherein said light emitting etch structures comprises an upconverting phosphor.

43. A light source device according to claim 35 wherein each of said plurality of light emitting etch structures comprise a light emitting layer made of a lumiphore.

44. A light source device according to claim 43 wherein said lumiphore is selected from any of the following:
organic dyes, organic dye aggregates, light emitting polymers, organic fluorophores, organic host-dopant combination materials, organic phosphors, inorganic phosphors, up converting phosphors, organic and inorganic nano-materials such as chemical quantum dots, semiconducting materials such as GaAs, OLED materials.

45. A light source device according to claim 35 wherein said plurality of light emitting etch structures comprise inorganic vertical cavity surface emitting lasers.

46. A light source device according to claim 35 wherein an overcoat is provided over said plurality of light emitting etch structures and light waveguides.

47. A light source device according to claim 35 wherein said deflection mechanism comprises at least one electrode provided for deflection of said portion of said waveguides.

48. A light source device according to claim 35 wherein said deflection mechanism comprises a pair of electrodes provided for deflection on said portion of said waveguides.

49. A light source device according to claim 35 wherein said deflection mechanism comprises a pair of electrodes disposed on both sides of at least one of light emitting etch structure and passing adjacent with at least one of said plurality of light waveguides whereby when a voltage is applied across said pair of electrodes a field is produced that causes said at least one waveguide to move into said electro-coupling region.

50. A light source device according to claim 46 wherein a control mechanism is provided for controlling the amount of said voltage across said pair of electrodes for controlling the distance in which said at least one waveguide moves into said electro-coupling region so as to control the amount of emission from said associated light emitting etch structure.

51. A light source device according to claim 35 wherein said plurality of light emitting etch structures are grouped into sets wherein each of said leaky etch structures emit a different color.

52. A light source device according to claim 35 wherein said plurality of light emitting etch structures emit a polarized light.

53. A light source device according to claim 35 wherein said plurality of light emitting etch structures emit a polarized light in a predetermined direction.

54. A light source device according to claim 35 wherein said plurality of light emitting etch structures are placed in groups that each form a generally circular pattern for controlling the polarization of light emitting from each of said groups.
